(19) United States
(12) Patent Application Publication
(10) Pub. No.: US 2002/0135817 A1
(43) Pub. Date: Sep. 26, 2002

(54) Data transmission scheme for scanner

(76) Inventor: Kuo-Jeng Wang, Kaohsiung (TW)

Correspondence Address: J.C. Patents, Inc., 1340 Reynolds Ave., Suite 114, Irvine, CA, 92614, US

(21) Appl. No.: 09/815,130

(22) Filed: Mar. 22, 2001

(51) Int. Cl. H04N 1/04

(52) U.S. Cl. 358/474

(57) ABSTRACT

A transmission system and a method of correctly transmitting scan data within a scanner. The transmission system includes a synchronous dynamic memory and a buffer unit. The synchronous dynamic memory serves not only as a storage unit for holding data, but also provides a masking function for processing the last remaining scan data. The buffer unit is coupled to the synchronous dynamic memory for holding the scan data sent by the synchronous dynamic memory.

### BACKGROUND OF THE INVENTION

1. Field of Invention

The present invention relates to a data transmission scheme for a scanner. More particularly, the present invention relates to a data transmission scheme for a scanner that uses the scanner's internal synchronous dynamic memory to transmit accurate scan data.

2. Description of Related Art

In the past, when a synchronous dynamic memory is accessing data in the burst mode, the quantity of data being access must be in a unit that can be processed in a burst mode transmission. Hence, unwanted scan data or padded data are sometimes written into or read from a synchronous dynamic memory.

Assume each burst mode transmission by the synchronous dynamic memory accesses four data units altogether. If one or two units of data remain near the end of a data transmission session, some data units adjacent to the last one or two data units need to be transmitted alongside the required data. Because only the first one or two data units are actually required, some padded or unwanted data units are transmitted leading to a lowering of transmission efficiency for the scanner.

### SUMMARY OF THE INVENTION

Accordingly, one object of the present invention is to provide a data transmission scheme for a scanner such that only the required scan data are access. The data transmission scheme for correct transmission of scan data uses a synchronous dynamic memory and a buffer.

The synchronous dynamic memory serves as a storage area for scan data and has a masking function for treating the last batch of data. The masking function can be applied to blank out unwanted scan data when the last remaining scan data is written from the synchronous dynamic memory to the buffer. Thus, the last batch of data written to the buffer is correct data. The buffer is connected to the synchronous dynamic memory for receiving the scan data and temporarily holding the scan data for subsequent transmission.

This invention also provides a method of transmitting correct scan data within a scanner. The invention relates to the utilization of a synchronous dynamic memory to process scan data correctly and quickly.

The correct transmission of scan data according to this invention includes the following steps. First, the quantity of data to be written into the synchronous dynamic memory is compared with the quantity of data capable of being processed in a burst mode transmission. If the quantity of scan data is greater than or equal to a burst mode transmission, a write command is executed so that the scan data is written into the synchronous dynamic memory. On the other hand, if the quantity of data to be written into the synchronous dynamic memory is smaller than a burst mode transmission, the scan data is checked to see if it is the last remaining scan data. If the scan data is the last remaining scan data, the write command is executed so that the last remaining scan data is written into the synchronous dynamic memory.

This invention also provides an alternative method of transmitting correct scan data within a scanner. The invention relates to the utilization of a synchronous dynamic memory to process scan data correctly and quickly.

The correct transmission of scan data according to the alternative method of this invention includes the following steps. First, the quantity of data stored inside the synchronous dynamic memory is compared with the quantity of data capable of being processed in a burst mode transmission. If the quantity of scan data inside the synchronous dynamic memory is greater or equal to a burst mode transmission, a read command is executed. Ultimately, the scan data in the synchronous dynamic memory are read out and written into a buffer. On the other hand, if the quantity of scan data in the synchronous dynamic memory is smaller than a burst mode transmission, the scan data is checked to see if it is the last remaining scan data. If the scan data is the last remaining scan data, the read command is executed so that the last remaining scan data is written into the buffer.

It is to be understood that both the foregoing general description and the following detailed description are exemplary, and are intended to provide farther explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram showing an equipment configuration for treating scan data inside a scanner according to a first preferred embodiment of this invention;

FIG. 2 is a block diagram showing an equipment configuration for treating scan data inside a scanner according to a second preferred embodiment of this invention;

FIG. 3 is a flow chart showing the progression of steps for writing batches of scan data into the synchronous dynamic memory using some internal components according to a first preferred embodiment of this invention;

FIG. 4 is a flow chart showing the progression of steps for reading batches of scan data from the synchronous dynamic memory using some internal components according to a second preferred embodiment of this invention; and

FIG. 5 is a diagram serving to illustrate the operation of the masking function inside a synchronous dynamic memory according to this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

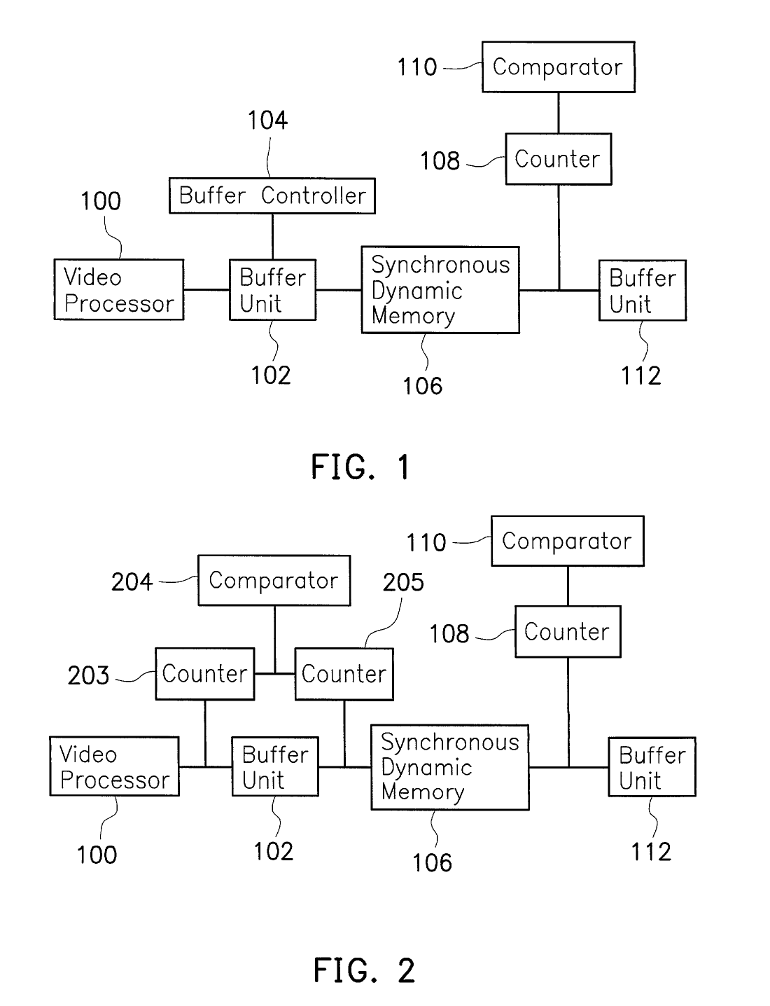

FIG. 1 is a block diagram showing an equipment configuration for treating scan data inside a scanner according to a first preferred embodiment of this invention. The equipment configuration for correctly transmitting scan data mainly includes a synchronous dynamic memory 106, a buffer unit 112, a video processor 100, a second buffer unit 102, a buffer controller 104, a counter 108 and a comparator 110.

The synchronous dynamic memory 106 is a location for holding scan data. The synchronous dynamic memory 106 also has a masking function for processing the last batch of scan data. The last batch of scan data is the amount of data left near the end of transmission such that the total amount is smaller than the transmission capacity of a burst mode transmission. The buffer unit 112 is directly connected to the synchronous dynamic memory 106 for receiving and temporarily holding the scan data sent from the synchronous dynamic memory 106.

The video processor 100 is a device for generating scan data. The buffer unit 102 is connected to the video processor 100 to serve as temporary storage for the scan data. The buffer controller 104 is connected to the buffer unit 102 for processing the scan data within the buffer unit 102. The video processor 100 will put a tag on the last batch of scan data in a data transmission session. Utilizing the tag attached to the last batch of data, the synchronous dynamic memory 106 is able to terminate the reading operation when the last batch is read. If the last batch of scan data is smaller than the amount of data the synchronous dynamic memory 106 can handle at a time, the synchronous dynamic memory performs a masking operation on the received data.

The counter 108 is coupled between the synchronous dynamic memory 106 and the buffer unit 112 for registering the amount of scan data written by the synchronous dynamic memory 106 into the buffer unit 112. The comparator 110 is connected to the counter 108 for comparing the currently transmitted data with the amount of scan data to be transmitted as registered by the counter 108.

When the amount of scan data reaches the pre-determined transmission quantity, the buffer controller 104 will trigger the buffer unit 102 to execute a read command. In here, the pre-determined transmission quantity refers to the amount of data that can be read or written in a burst mode transmission. In addition, the last batch of scan data refers to an amount of data smaller than the total amount of data a burst mode transmission is able to handle.

FIG. 2 is a block diagram showing an equipment configuration for treating scan data inside a scanner according to a second preferred embodiment of this invention. The equipment configuration for correctly transmitting scan data mainly includes a synchronous dynamic memory 106, a buffer unit 112, a video processor 100, a second buffer unit 102, a counter 203, a second counter 205, a comparator 204, a third counter 108 and a second comparator 110.

The synchronous dynamic memory 106 is a location for holding scan data. The synchronous dynamic memory 106 also has a masking function for processing the last batch of scan data. The buffer unit 112 is connected to the synchronous dynamic memory 106 for receiving and temporarily holding the scan data sent from the synchronous dynamic memory 106.

The video processor 100 is a device for generating scan data. The buffer unit 102 is connected to the video processor 100 to serve as temporary storage for the scan data. The counter 203 is coupled between the video processor 100 and the buffer unit 102 to count the quantity of scan data transmitted from the video processor 100 to the buffer unit 102. The counter 105 is coupled between the buffer unit 102 and the synchronous dynamic memory 106 to count the quantity of scan data transmitted from the buffer unit 102 to the synchronous dynamic memory 106. The comparator 204 is coupled between the counter 203 and the counter 205 to compare the values between the counter 203 and the counter 205. Ultimately, the comparator 204 is able to obtain the difference in scan data transmission between the two counters.

The counter 108 is coupled between the synchronous dynamic memory 106 and the buffer unit 112 to count the quantity of data transmitted from the synchronous dynamic memory 106 to the buffer unit 112. The comparator 110 is connected to the counter 108 for comparing the currently transmitted data with the amount of scan data to be transmitted as registered by the counter 108.

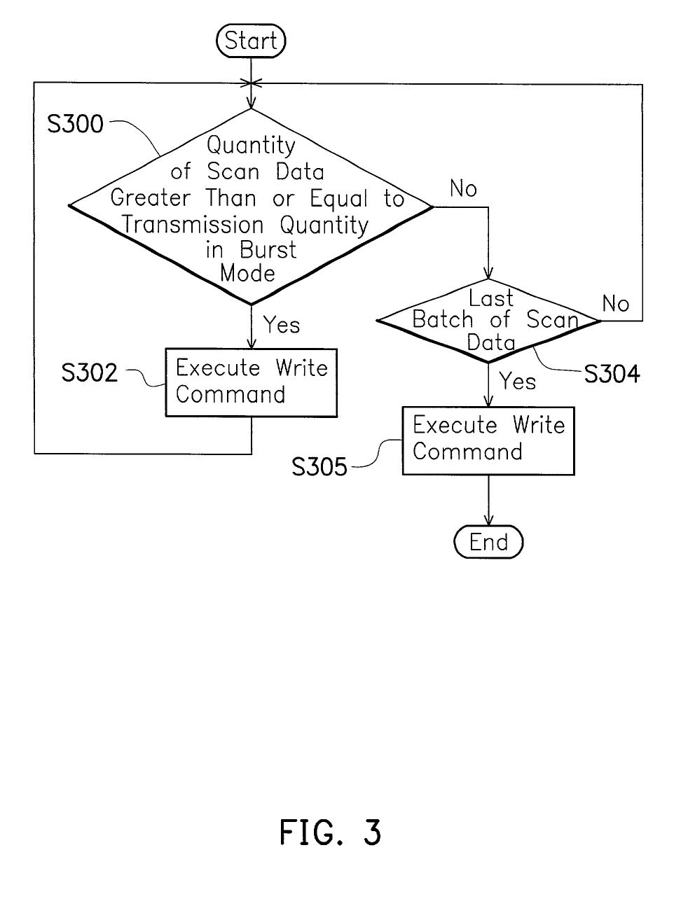

FIG. 3 is a flow chart showing the progression of steps for writing batches of scan data into the synchronous dynamic memory using some internal components according to a first preferred embodiment of this invention. In step S300, the quantity of data to be written into the synchronous dynamic memory is compared with the quantity of data capable of being processed in a burst mode transmission. If the quantity of scan data is greater than or equal to a burst mode transmission, a write command (step S302) is executed so that the scan data is written into the synchronous dynamic memory. When the execution of the write command is complete, control is returned to step S300. The aforementioned process is repeated until the amount of scan data is less than a transmission quantity. If the quantity of data to be written into the synchronous dynamic memory is smaller than the transmission quantity, the scan data (in step 304) is checked to see if it is the last remaining scan data. If the scan data is the last remaining scan data, the write command (in step S305) is executed so that the last remaining scan data is written into the synchronous dynamic memory. On the other hand, if the scan data is not the last remaining scan data, control is returned to step S300 so that the previous cycle is repeated until the last batch of data remains. Whether the batch of written data is the last remaining scan data or not can be determined by looking for the presence of tags.

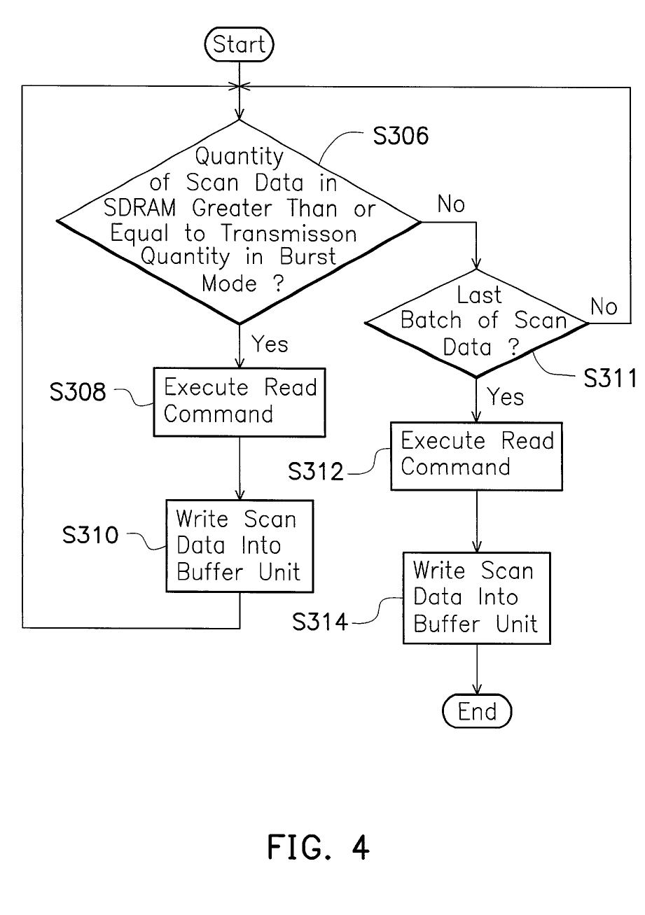

FIG. 4 is a flow chart showing the progression of steps for reading batches of scan data from the synchronous dynamic memory using some internal components according to a second preferred embodiment of this invention. In step S360, the quantity of scan data to be read from the synchronous dynamic memory is compared with the quantity of data capable of being processed in a burst mode transmission. If the quantity of scan data is greater than or equal to a burst mode transmission, a read command (step S308) is executed so that the scan data in the synchronous dynamic memory are read out. In step 310, the scan data is written into the buffer unit. If the quantity of scan data read from the synchronous dynamic memory is still larger than a burst mode transmission, control is returned to step S306. The aforementioned process is repeated until the amount of scan data in the synchronous dynamic memory is less than a transmission quantity. If the quantity of data to be read from the synchronous dynamic memory is smaller than the transmission quantity, the scan data (in step 311) is checked to see if it is the last remaining scan data. If the scan data is the last remaining scan data, the read command (in step S312) is executed so that the last remaining scan data is read and then transferred to into the buffer unit (in step S314). On the other hand, if the scan data is not the last remaining scan data, control is returned to step S306 so that the previous cycle is repeated until the last batch of data remains. To prevent the transmission of unwanted data due to insufficient data in a burst mode transmission, the masking function in the synchronous dynamic memory is use to blank out the accompanied unwanted data.

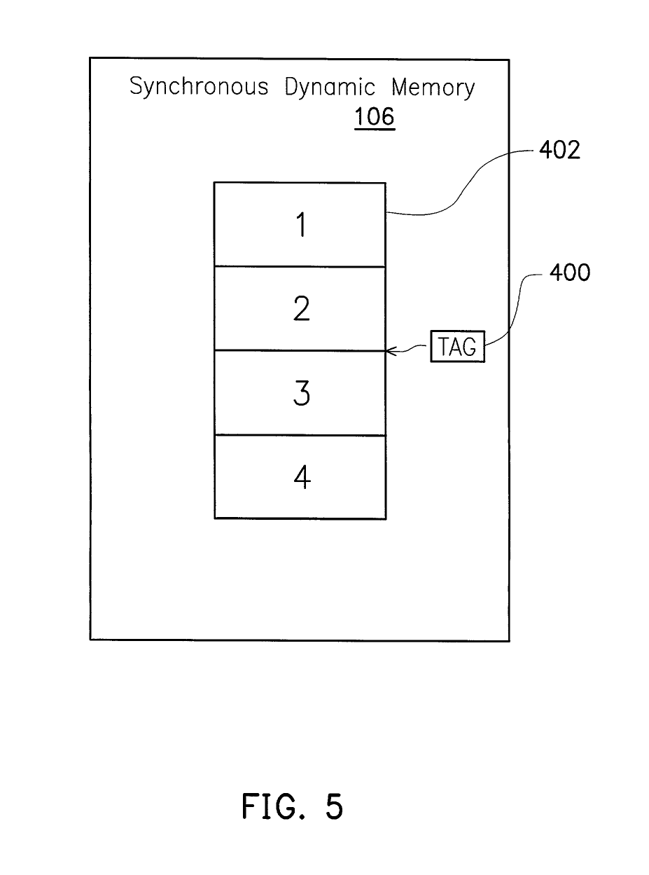

FIG. 5 is a diagram serving to illustrate the operation of the masking function inside a synchronous dynamic memory according to this invention. The synchronous dynamic memory 106 needs to transmit the last remaining scan data 402, in other words, the scan data 1, 2, 3, and 4 as shown in FIG. 5. If a tag 400 is found in the last two batches of the scan data 402, the two batches of data with the tag on is regarded as the last transmission data. Since the first two batches are the last transmission data, the third and the fourth batch of scan data is redundant and should be discarded. Utilizing the masking function of the synchronous dynamic memory, the last two batches of scan data are blanked out leaving the correct data in the last transmission.

In summary, the advantage of this invention is the correct transmission of scan data even if a fraction of the transmitted data in a burst mode transmission is useful.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A transmission configuration for correctly processing batches of scan data within in a scanner, comprising:
a synchronous dynamic memory for holding scan data, wherein the synchronous dynamic memory also has a masking function for processing a portion of the scan data; and
a first buffer unit coupled to the synchronous dynamic memory serving as a temporary storage area of scan data sent from the synchronous dynamic memory.

2. The transmission configuration of claim 1, wherein the masking function of the synchronous dynamic memory is capable of blanking unwanted data when the quantity of useful scan data is less than the quantity of data a burst mode can transmit.

3. The transmission configuration of claim 1, wherein the transmission configuration further includes:
a video processor for generating scan data;
a second buffer unit coupled to the video processor for holding scan data transmitted from the video processor;
a buffer controller coupled to the second buffer unit for processing the stored scan data within the second buffer unit;
a first counter coupled between the synchronous dynamic memory and the first buffer unit for computing the quantity of scan data transmitted from the synchronous dynamic memory to the first buffer unit; and
a first comparator coupled to the first counter for comparing a preset data transmission quantity and the quantity of scan data registered in the first counter and computing their difference.

4. The transmission configuration of claim 3, wherein the last remaining batch of scan data is tagged by the video processor.

5. The transmission configuration of claim 4, wherein the synchronous dynamic memory is able to transmit the last batch of scan data and terminates read operation based on the tag on the scan data.

6. The transmission configuration of claim 5, wherein the synchronous dynamic memory initiates a blanking operation when the last remaining batch of data do not have sufficient quantity of data to occupy all the data slots for a burst mode transmission.

7. The transmission configuration of claim 3, wherein the buffer controller triggers the second buffer unit into executing a read command when the second buffer unit has received the preset transmission quantity.

8. The transmission configuration of claim 3, wherein the preset transmission quantity is the amount of data capable of being read or written in a burst mode transmission.

9. The transmission configuration of claim 3, wherein the buffer controller further includes:
a second counter coupled between the video processor and the second buffer unit serving to compute the quantity of scan data transmitted from the video processor to the second buffer unit;
a third counter coupled between the second buffer unit and the synchronous dynamic memory to compute the quantity of scan data transmitted from the second buffer unit to the synchronous dynamic memory; and
a second comparator coupled between the second counter and the third counter for comparing the values obtained from the second and the third counter and finding their difference.

10. A method for correctly transmitting batches of scan data to a synchronous dynamic memory using the internal devices within a scanner, comprising the steps of:
(a) determining if the quantity of scan data written into the synchronous dynamic memory is greater than or equal to the transmission quantity of a burst mode transmission;
(b) executing a write command so that the scan data is written into the synchronous dynamic memory if the quantity of scan data is greater than or equal to the transmission quantity;
(c) determining if the scan data is the last remaining scan data if the quantity of scan data is smaller than the transmission quantity;
(d) executing a write command so that the last remaining scan data is written into the synchronous dynamic memory if the scan data is the last remaining scan data; and
(e) returning to step (a) if the scan data is not the last remaining scan data until all the scan data is written into the synchronous dynamic memory.

11. The method of claim 10, wherein the step of determining if the scan data is the last remaining scan data or not includes finding a tag in the scan data.

12. A method for correctly reading out batches of scan data from a synchronous dynamic memory using the internal devices within a scanner, comprising the steps of:
(a) determining if the quantity of scan data in the synchronous dynamic memory is greater than or equal to the transmission quantity of a burst mode transmission;
(b) executing a read command so that the scan data is read from the synchronous dynamic memory and written into a buffer unit if the quantity of scan data is greater than or equal to the transmission quantity;
(c) determining if the scan data is the last remaining scan data if the quantity of scan data is smaller than the transmission quantity;
(d) executing a read command so that the last remaining scan data is written into the buffer unit if the scan data is the last remaining scan data; and
(e) determining if the quantity of scan data stored in the synchronous dynamic memory is greater than or equal to the transmission quantity of a burst mode transmission if the scan data is not the last remaining scan data, continuing until all the scan data are read from the synchronous dynamic memory and written into the buffer unit.

13. The method of claim 12, wherein the blanking function of the synchronous dynamic memory can be used to blank out redundant data when the quantity of scan data is less than the transmission quantity in a burst mode transmission.
